(19) United States
(12) Patent Application Publication
(10) Pub. No.: US 2026/0272192 A1
(43) Pub. Date: Sep. 17, 2026

(54) Pegboard Assembly

(71) Applicant: DELI GROUP CO. LTD, Ningbo, Zhejiang (CN)

(72) Inventors: Hongyu QI, Ningbo, Zhejiang (CN); Yuangang YANG, Ningbo, Zhejiang (CN); Chong ZHENG, Ningbo, Zhejiang (CN)

(21) Appl. No.: 19/471,350

(22) PCT Filed: Jul. 4, 2024
(86) PCT No.: PCT/CN2024/103701

§ 371 Date: Sep. 30, 2025

(30) Foreign Application Priority Data
Sep. 18, 2023 (CN) 202322526258.2

(51) Int. Cl. A47F 5/08; A47B 97/00

(52) U.S. Cl. CPC A47F 5/0815; A47B 97/001

(57) ABSTRACT

The present disclosure relates to a pegboard assembly, including at least one pegboard body, wherein the pegboard body is provided with several hanging holes and at least one connecting portion, and a connecting plate and a button are connected to the connecting portion; the connecting plate is in buckling connection with the connecting portion on the rear side of the pegboard body, and the connecting plate is used for installing the pegboard body on a wall or a door panel; and the button is connected with the connecting portion on the front side of the pegboard body, and the buckling connection between the connecting plate and the connecting portion may be released by pressing the button. In the present disclosure, the pegboard body can be conveniently installed, and the pegboard body can also be conveniently disassembled.

### CROSS-REFERENCE TO RELATED APPLICATION

The present disclosure is a national stage application of International Patent Application No. PCT/CN2024/103701, which is filed on Jul. 4, 2024, and claims priority to Chinese Patent Application No. 202322526258.2, filed on Sep. 18, 2023 and entitled “Pegboard Assembly”, the contents of which are hereby incorporated by reference in its entirety.

### TECHNICAL FIELD

The present disclosure relates to the technical field of storage and display devices, and more particularly to a pegboard assembly.

### BACKGROUND

A pegboard can be used with a plurality of hooks, and a user randomly hangs a plurality of articles according to requirements, so that the pegboard is diversified in use form and flexible to use, and thus is deeply loved by the user.

At present, pegboards on the market can only be installed on walls for use, and when the pegboard is installed, it is usually necessary to dig a hole on the wall, and then the pegboard is fixed on the wall by screws, which is relatively troublesome in operation and is inconvenient in disassembly and assembly.

### SUMMARY

The technical problem to be solved in the present disclosure is to provide a pegboard assembly, wherein a pegboard can be installed on a wall very conveniently and can also be conveniently disassembled from the wall.

The technical solution of the present disclosure is to provide a pegboard assembly, including at least one pegboard body, wherein the pegboard body is configured with several hanging holes and at least one connecting portion, and a connecting plate and a button are connected to the connecting portion; the connecting plate is in buckling connection with the connecting portion on the rear side of the pegboard body, and the connecting plate is used for installing the pegboard body on a wall or a door panel; and the button is connected with the connecting portion on the front side of the pegboard body, and the buckling connection between the connecting plate and the connecting portion can be released by pressing the button.

Compared with the art known to inventors, the pegboard assembly of the present disclosure has the following advantages: the pegboard body can be conveniently installed, the connecting plate can be installed on the wall or the door panel at first, and then the pegboard body is in buckling connection with the connecting plate, so that the pegboard body can be conveniently installed; the pegboard body can also be conveniently disassembled, if it is necessary to take off the pegboard body, the buckling connection between the connecting plate and the connecting portion can be released just by pressing the button, so that the pegboard body can be disassembled very conveniently; and the connecting plate can be pasted on the wall or the door panel by a back adhesive, and can also be fixed on the wall or the door panel by screws.

In some embodiments, a buckling hole is formed inside the connecting portion, and the inner side wall of the buckling hole is configured with a connecting plate buckling position; the connecting plate is configured with a clamping convex column, and a side wall of the clamping convex column is configured with a clamping hook; and the clamping convex column is inserted into the buckling hole, the clamping hook is in buckling connection with the connecting plate buckling position, when the button is pressed, the button can push the clamping convex column to move radially, so that the clamping hook deviates from the connecting plate buckling position. By using the structure, it is convenient to release the buckling connection between the connecting plate and the connecting portion; when the clamping hook is only located on one side of the clamping convex column, the button can be wedge-shaped, when the button is pressed, a front end of the button is wedged into the outer side of the clamping hook to push the clamping convex column to move radially, so that the clamping hook deviates from the connecting plate buckling position; when the clamping hook is located on two sides of the clamping convex column or surrounds the outer side wall of the clamping convex column, the button can be annular, at this time, the outer side wall of the clamping convex column is generally set to have elasticity, and when the button is pressed, the front end of the button is wedged into the outer side of the clamping hook to push the clamping convex column to move radially to contract, so that the clamping hook deviates from the connecting plate buckling position.

In some embodiments, the clamping convex column is configured with a convex column side edge groove, and a front end of the clamping convex column is configured with a chamfer inclined plane; a front end of the button is configured with a button ring wall, and an end surface of the button ring wall is opposite to the chamfer inclined plane; and by pushing the button into the buckling hole, the front end of the clamping convex column can be inserted into the button ring wall, the end surface of the button ring wall slides along the chamfer inclined plane and extrudes the clamping convex column radially, and the clamping convex column extrudes the convex column side edge groove to generate radial contraction until the clamping hook deviates from the connecting plate buckling position. By using the structure, the convex column side edge groove is configured to enable the outer side wall of the clamping convex column to have radial elasticity, and the end surface of the button ring wall can slide along the chamfer inclined plane to extrude the clamping convex column radially, so that the clamping convex column generates radial contraction, and thus the clamping hook can conveniently deviate from the connecting plate buckling position.

In some embodiments, the inner side wall of the buckling hole is configured with a button buckling position, and the button buckling position is located on the front side of the connecting plate buckling position; the outer side wall of the button is configured with a button clamping hook; the button is inserted into the buckling hole, and the button clamping hook is in buckling connection with the button buckling position; and by pressing the button, the button can be caused to move towards the rear side of the buckling hole; and when the clamping convex column is inserted into the buckling hole, the button can be pushed to move towards the front side of the buckling hole and the button buckling position limits the button. By using the structure, when the clamping convex column is inserted into the buckling hole, the button cannot deviate from the buckling hole during the process of moving towards the front side of the buckling hole, so that the button is prevented from falling and being lost due to the fact that the button deviates from the buckling hole.

In some embodiments, the pegboard assembly includes at least two pegboard bodies, and each of the at least two pegboard bodies can be spliced up and down or spliced left and right; a spliced side of each of the at least two pegboard bodies is configured with a connecting portion, the connecting portion is configured with at least one plate body screw hole, and the plate body screw hole is located between the buckling hole and a spliced side wall of the pegboard body; the connecting plate is respectively configured with one connecting plate screw counter bore on two sides of the clamping convex column, and the clamping convex column is configured with the convex column side edge groove; and after two pegboard bodies are spliced together, one connecting plate can be connected inside two connecting portions at the joint of the two pegboard bodies at the same time, the spliced side walls of the two pegboard bodies are embedded into the convex column side edge groove of the clamping convex column, and two connecting plate screw counter bores are in one-to-one correspondence with the plate body screw holes of the two connecting portions and are connected by screws. By using the structure, it is convenient for the connecting plate to fix the two spliced pegboard bodies, and the connecting plate and the two spliced pegboard bodies are connected by screws, so that the structure of the two spliced pegboard bodies is stable and is not easy to fall apart.

In some embodiments, the connecting plate is respectively configured with one connecting plate edge bump on the outer sides of the two connecting plate screw counter bores, and when one connecting plate is connected inside the two connecting portions at the joint of the two pegboard bodies at the same time, the two connecting plate edge bumps are inserted into the buckling holes of the two connecting portions in an one-to-one correspondence manner; and when the screw connections between the two connecting plate screw counter bores and the plate body screw holes of the two connecting portions are released, the buttons in the buckling holes of the two connecting portions are pressed at the same time, the end surfaces of the button ring walls of the two buttons can respectively push the two connecting plate edge bumps to exit the buckling holes of the two connecting portions. By using the structure, when the screw connections between the two connecting plate screw counter bores and the plate body screw holes of the two connecting portions are released, by pressing the buttons in the buckling holes of the two connecting portions, the connecting plate can be conveniently disassembled from the two pegboard bodies.

In some embodiments, the spliced side walls of the two pegboard bodies embedded into the convex column side edge groove are each configured with a plate body edge avoidance groove, the plate body edge avoidance groove is located on the inner side surface of the spliced side wall of the pegboard body, and the spliced side walls of the two pegboard bodies are embedded into the convex column side edge groove at positions where the plate body edge avoidance grooves are located. By using the structure, the plate body edge avoidance groove is formed to thin the spliced side wall of the pegboard body located at the plate body edge avoidance groove, which facilitates to smoothly embed the spliced side walls of the two pegboard bodies into the convex column side edge groove, thereby avoiding the interference between the clamping convex column and the spliced side walls of the two pegboard bodies.

In some embodiments, the periphery of the connecting plate is configured with side walls; two side walls of the connecting plate, respectively opposite to the two ends of the convex column side edge groove, are both configured with connecting plate side wall avoidance grooves; the two connecting plate side wall avoidance grooves are opposite to each other; and when one connecting plate is connected inside the two connecting portions at the joint of the two pegboard bodies at the same time, the spliced side walls of the two pegboard bodies are embedded into the two opposite connecting plate side wall avoidance grooves. By using the structure, the periphery of the connecting plate is configured with the side walls, which facilitates the side walls of the connecting plate to support the connecting portion of the pegboard body; and by forming the connecting plate side wall avoidance grooves, the interference between the side walls of the connecting plate and the spliced side walls of the two pegboard bodies can be avoided.

In some embodiments, a back surface of the connecting plate is configured with a back adhesive, and the back adhesive is used for pasting the connecting plate on the wall or the door; or, the connecting plate is configured with a fixing screw hole, and the connecting plate is connected to the wall with screw through the fixing screw hole. By using the structure, the connecting plate is pasted on the wall or the door by the back adhesive, or is connected to the wall with screw through the fixing screw hole, thereby being convenient to operate.

In some embodiments, the connecting plate is configured with at least two bolt holes, an on-door hook is connected to each bolt hole by a bolt; the on-door hook includes a hook portion and a connecting portion, the connecting portion is connected to the bolt hole by a bolt, and the hook portion is used for hanging the connecting plate on an upper edge of a cabinet door or a room door. By using the structure, the connecting plate can be hooked on the upper edge of the cabinet door or the room door by the on-door hook, thereby increasing application scenarios of the pegboard assembly of the present disclosure.

In some embodiments, the connecting plate is configured with at least two bolt holes, a desktop connecting member is connected to each bolt hole by a bolt; the desktop connecting member includes an upper clamping piece and a lower clamping piece, which are L-shaped; upper portions of the upper clamping piece and the lower clamping piece are connected to the bolt holes by bolts at the same time, a lower portion of the upper clamping piece is opposite to a lower portion of the lower clamping piece; the lower portion of the lower clamping piece is configured with an adjusting stud, a top end of the adjusting stud is configured with a clamping cap, the distance between the clamping cap and the lower portion of the upper clamping piece can be adjusted by screwing the adjusting stud, and the clamping cap and the lower portion of the upper clamping piece are used for clamping the connecting plate on the edge of a table plate. By using the structure, the connecting plate can be clamped on the edge of the table plate by the desktop connecting member, thereby increasing application scenarios of the pegboard assembly of the present disclosure.

In some embodiments, the pegboard body is configured with at least one of a storage box and a storage tray, the at least one of the storage box and the storage tray is hung on the hanging holes, and the storage tray is configured with a pen container. By using the structure, the pegboard body is configured with the at least one of the storage box and the storage tray, so that a plurality of storage objects can be accommodated, and thus the storage capacity is high.

### BRIEF DESCRIPTION OF THE DRAWINGS

FIG. 1 is a schematic structural diagram of a back surface of a pegboard assembly of Embodiment 1 of the present disclosure.

FIG. 2 is a schematic structural diagram of a front surface of a pegboard assembly of Embodiment 1 of the present disclosure.

FIG. 3 is a schematic diagram of an exploded structure of a pegboard assembly of Embodiment of the present disclosure.

FIG. 4 is an enlarged view of a region E in FIG. 3.

FIG. 5 is an enlarged view of a region F in FIG. 3.

FIG. 6 is a schematic structural diagram of a B-B cross section of a region A in FIG. 1.

FIG. 7 is a schematic structural diagram of a back surface of a pegboard assembly of Embodiment 2 of the present disclosure.

FIG. 8 is a schematic structural diagram of a front surface of a pegboard assembly of Embodiment 2 of the present disclosure.

FIG. 9 is schematic diagram of an exploded structure of a pegboard assembly of Embodiment 2 of the present disclosure.

FIG. 10 is an enlarged view of a region M in FIG. 9.

FIG. 11 is an enlarged view of a region N in FIG. 9.

FIG. 12 is a schematic structural diagram of a D-D cross section of a region C in FIG. 7.

FIG. 13 is a schematic structural diagram of an on-door hook of a pegboard assembly of the present disclosure.

FIG. 14 is a schematic structural diagram of a desktop connecting member of a pegboard assembly of the present disclosure.

FIG. 15 is a schematic structural diagram of storage members on a pegboard assembly of the present disclosure.

As shown in the figures:
1, pegboard body; 1-1, hanging hole; 1-2, connecting portion;
1-3, buckling hole; 1-31, connecting plate buckling position; 1-32, button buckling position;
1-4, plate body screw hole; 1-5, plate body edge avoidance groove;
2, connecting plate; 2-1, clamping convex column; 2-11, clamping hook; 2-12, convex column side edge groove; 2-13, chamfer inclined plane; 2-2, connecting plate screw counter bore; 2-3, bolt hole; 2-4, connecting plate side wall avoidance groove; 2-5, connecting plate edge bump;
3, button; 3-1, button clamping hook; 3-2, button ring wall; 3-3, ring wall end surface;
4, back adhesive; 5, screw;
6, on-door hook; 6-1, hook portion; 6-2, connecting portion;
7, desktop connecting member; 7-1, upper clamping piece; 7-2, lower clamping piece;
7-3, adjusting stud; 7-4, clamping cap;
8, storage box; 9, storage tray; 9-1, pen container.

### DETAILED DESCRIPTION OF THE EMBODIMENTS

To better understand the present disclosure, various aspects of the present disclosure will be described in more detail with reference to the drawings. It should be understood that these detailed descriptions are merely descriptions of exemplary implementations of the present disclosure, and are not intended to limit the scope of the present disclosure in any way. Identical reference signs indicate identical elements throughout the specification.

In the drawings, for ease of description, the thickness, size and shape of an object have been slightly exaggerated. The drawings are merely examples and are not strictly drawn to scale.

It should also be understood that, the terms “include”, “have”, “contain” and “containing”, when used in the present specification, indicate the presence of features, integers, steps, operations, elements, and/or components, but do not preclude the presence or addition of one or more other features, integers, steps, operations, elements, components, and combinations thereof. Further, when an expression, such as “at least one”, appears after a list of features, the expression modifies the entire list of features, rather than modifying individual elements in the list.

### Embodiment 1

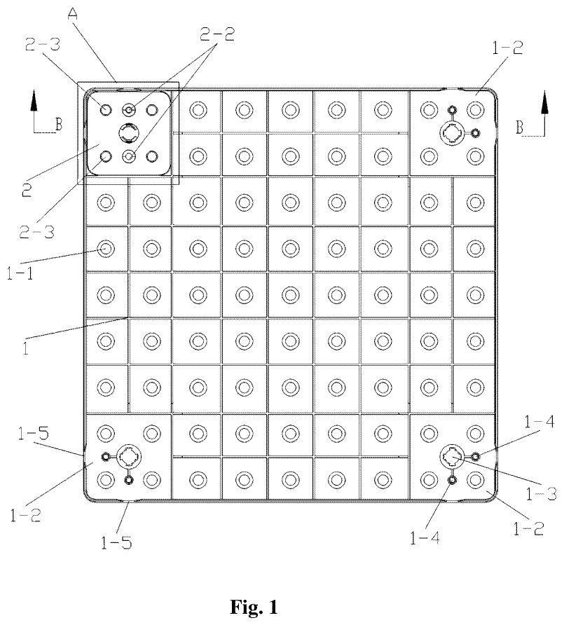

As shown in FIG. 1, a pegboard assembly of the present disclosure includes a pegboard body 1, the pegboard body 1 is square, four corners of the pegboard body 1 are each configured with one connecting portion 1-2, other positions of the pegboard body 1 are configured with several hanging holes 1-1, and the several hanging holes 1-1 form a regular array.

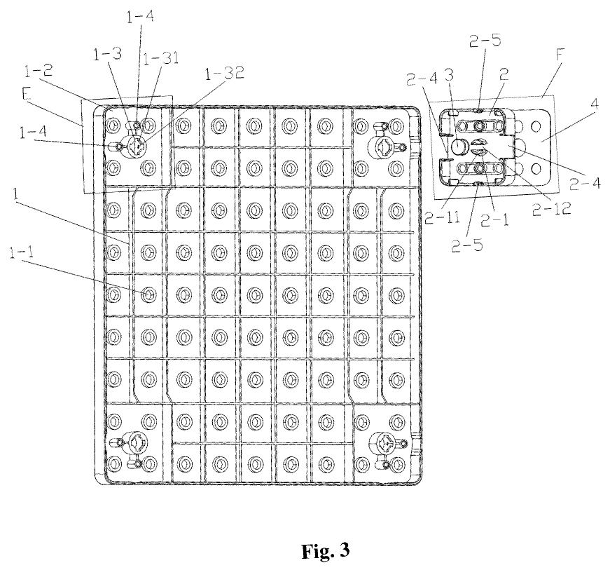

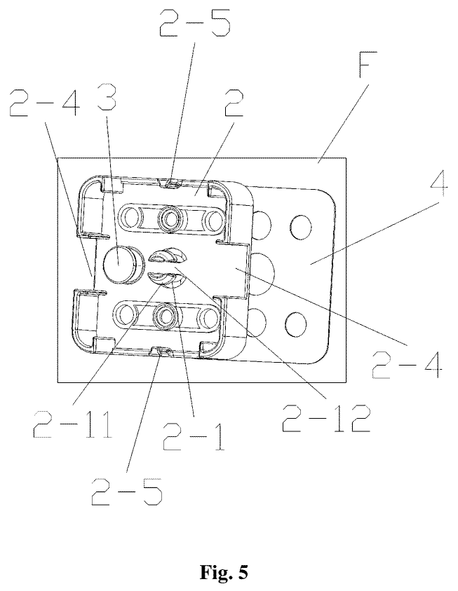

As shown in FIG. 1 and FIG. 3 to FIG. 5, the center of the connecting portion 1-2 is configured with a buckling hole 1-3, and the inner side wall of the buckling hole 1-3 is configured with a connecting plate buckling position 1-31. A connecting plate 2 is connected to the connecting portion 1-2, the connecting plate 2 is configured with a clamping convex column 2-1, a side wall of the clamping convex column 2-1 is configured with a clamping hook 2-11, the clamping convex column 2-1 is inserted into the buckling hole 1-3 on the rear side of the pegboard body 1, and the clamping hook 2-11 is in buckling connection with the connecting plate buckling position 1-31, that is, the connecting plate 2 can be in buckling connection with the pegboard body 1.

The clamping convex column 2-1 is further configured with a convex column side edge groove 2-12, and the convex column side edge groove 2-12 enables the side wall of the clamping convex column 2-1 to have radial contraction elasticity. A back surface of the connecting plate 2 is configured with a back adhesive 4, and the connecting plate 2 can be pasted on a wall or a door by the back adhesive 4, so that the pegboard body 1 can be conveniently installed on the wall or the door panel by clamping the pegboard body 1 on the connecting plate 2.

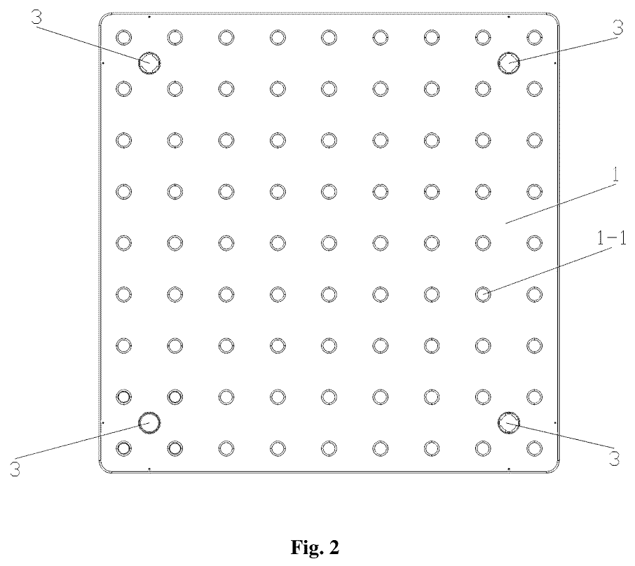

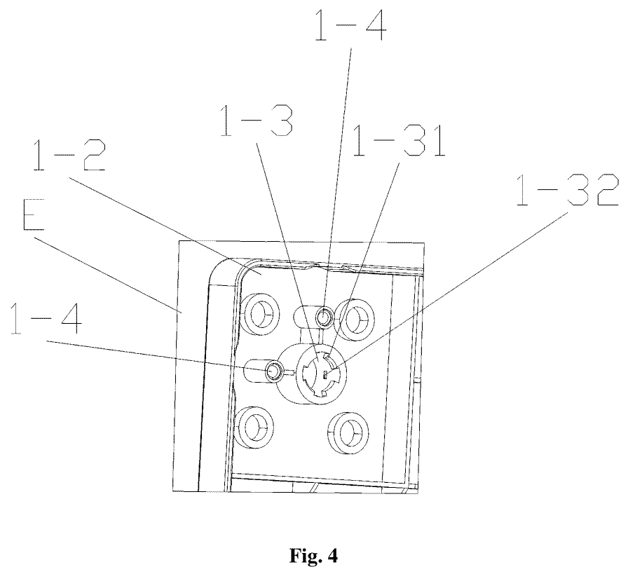

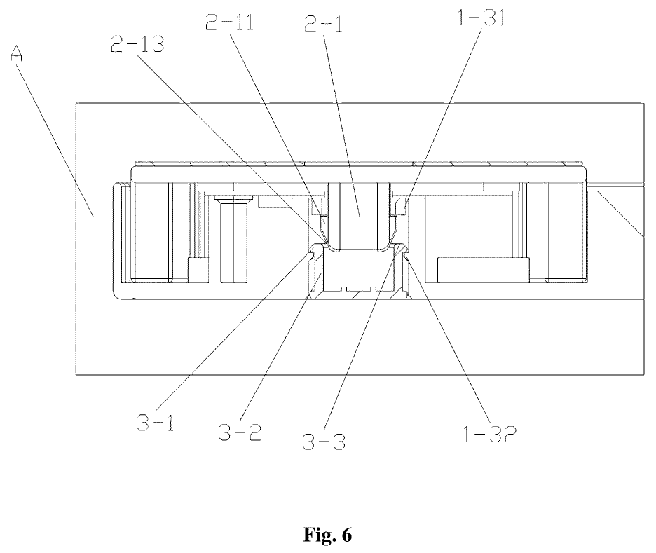

As shown in FIG. 4, the inner side wall of the buckling hole 1-3 is configured with a button buckling position 1-32, the button buckling position 1-32 is located on the front side of the connecting plate buckling position 1-31. As shown in FIG. 2 and FIG. 6, the buckling hole 1-3 is further internally configured with a button 3, the outer side wall of the button 3 is configured with a button clamping hook 3-1, the button 3 is inserted into the buckling hole 1-3 on the front side of the pegboard body 1, and the button clamping hook 3-1 is in buckling connection with the button buckling position 1-32.

As shown in FIG. 6, a front end of the clamping convex column 2-1 is configured with a chamfer inclined plane 2-13; a front end of the button 3 is configured with a button ring wall 3-2, an end surface of the button ring wall 3-2 is a ring wall end surface 3-3, and the button clamping hook 3-1 is disposed on the outer side of the ring wall end surface 3-3. In the buckling hole 1-3, the end surface of the button ring wall 3-2 is opposite to the chamfer inclined plane 2-13. When the button 3 is pressed on the front side of the pegboard body 1, the button 3 can move towards the rear side of the buckling hole 1-3, so that the front end of the clamping convex column 2-1 is inserted into the button ring wall 3-2, then the button 3 is continuously pressed, the end surface of the button ring wall 3-2 slides along the chamfer inclined plane 2-13 and radially extrudes the clamping convex column 2-1, and the clamping convex column 2-1 extrudes the convex column side edge groove 2-12 to generate radial contraction, so that the clamping hook 2-11 can finally deviate from the connecting plate buckling position 1-31. That is, by pressing the button 3, the clamping convex column 2-1 can be pushed to move radially to enable the clamping hook 2-11 to deviate from the connecting plate buckling position 1-31, so that the buckling connection between the connecting plate 2 and the connecting portion 1-2 is released, and accordingly, the pegboard body 1 can be conveniently disassembled from the connecting plate 2.

When the pegboard body 1 is connected to the connecting plate 2 again, when the clamping convex column 2-1 is inserted into the buckling hole 1-3, the button 3 can be pushed to move towards the front side of the buckling hole 1-3, and the button buckling position 1-32 limits the button 3 to prevent the button 3 from deviating from the buckling hole 1-3.

In the present embodiment, a screw hole can also be formed in the connecting plate 2, so that the connecting plate 2 can be firmly connected to a wall or a door by screw.

### Embodiment 2

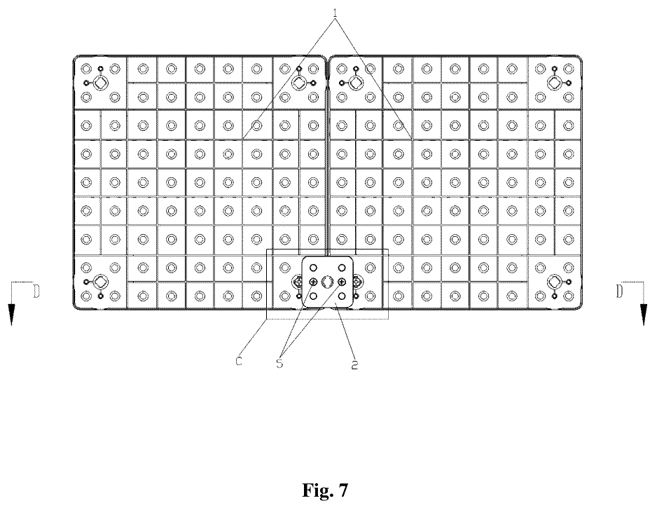

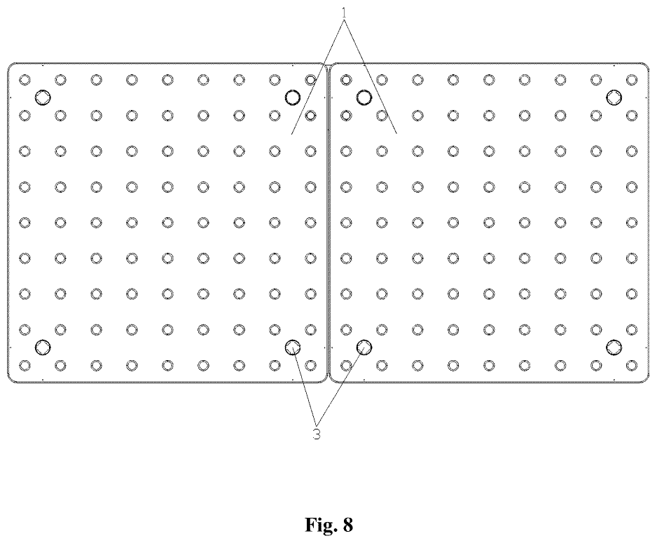

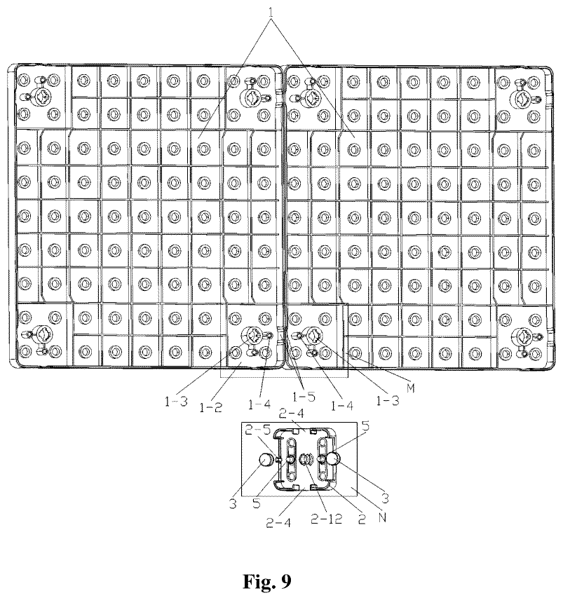

The pegboard assembly of the present embodiment differs from Embodiment 1 in that, as shown in FIG. 7, the pegboard assembly of the present embodiment includes two pegboard bodies 1 as described in Embodiment 1 and one connecting plate 2 as described in Embodiment 1. The two pegboard bodies 1 are spliced left and right, the connecting portions 1-2 on spliced sides of the two pegboard bodies 1 are adjacent to each other left and right, one connecting plate 2 is simultaneously connected in the two left and right adjacent connecting portions 1-2 of the two pegboard bodies 1, and one button 3 as described in Embodiment 1 is respectively disposed in the buckling holes 1-3 of the two left and right adjacent connecting portions 1-2, as shown in FIG. 8. As shown in FIG. 9 to FIG. 11, each of the connecting portions 1-2 is configured with one plate body screw hole 1-4, and the plate body screw hole 1-4 is located between the buckling hole 1-3 and a spliced side wall of the pegboard body 1. The connecting plate 2 is configured with one connecting plate screw counter bore 2-2 on two sides of the clamping convex column 2-1, and the two connecting plate screw counter bores 2-2 are in one-to-one correspondence with the plate body screw holes 1-4 in the two left and right adjacent connecting portions 1-2 on the two pegboard bodies 1 and are connected by screws 5.

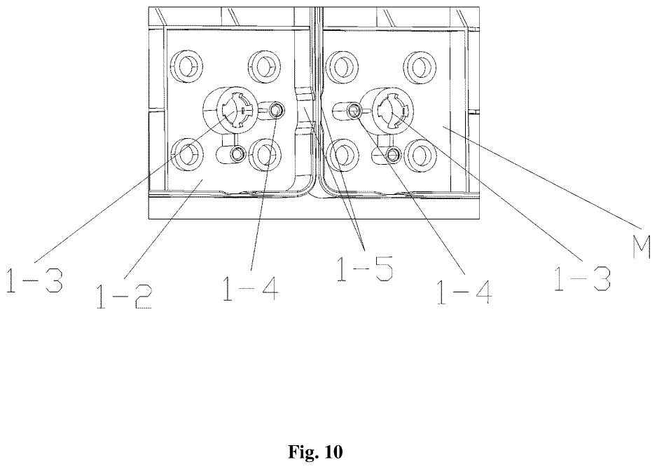

The periphery of the connecting plate 2 is configured with side walls; two side walls of the connecting plate 2, respectively opposite to the two ends of the convex column side edge groove 2-12, are both configured with connecting plate side wall avoidance grooves 2-4; and the two connecting plate side wall avoidance grooves 2-4 are opposite to each other. The spliced side walls of the two pegboard bodies 1 are embedded into the two opposite connecting plate side wall avoidance grooves 2-4 and the convex column side edge groove 2-12 of the clamping convex column 2-1, as shown in FIG. 9 and FIG. 10. Outer side surfaces of the spliced side walls of the two pegboard bodies 1 are attached to each other; and the spliced side walls of the two pegboard bodies 1 embedded into the convex column side edge groove 2-12 are each configured with a plate body edge avoidance groove 1-5; the plate body edge avoidance grooves 1-5 are located on the inner side surfaces of the spliced side walls of the pegboard bodies 1, and the plate body edge avoidance grooves 1-5 reduce the thickness of the spliced side walls of the two pegboard bodies 1, which are embedded into the convex column side edge groove 2-12, thereby preventing the interference between the spliced side walls of the two pegboard bodies 1 and the clamping convex column 2-1.

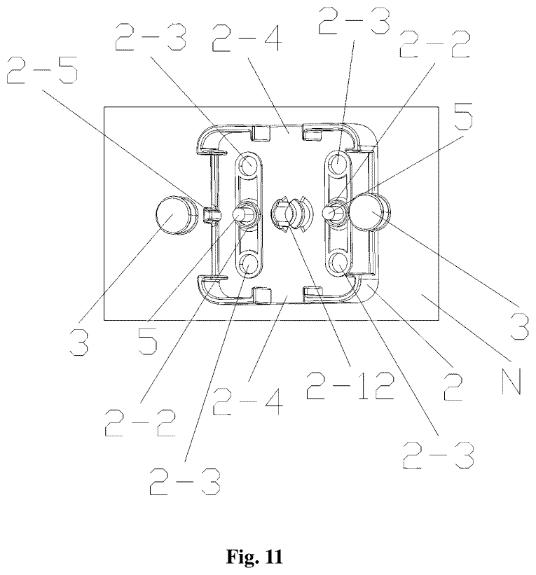

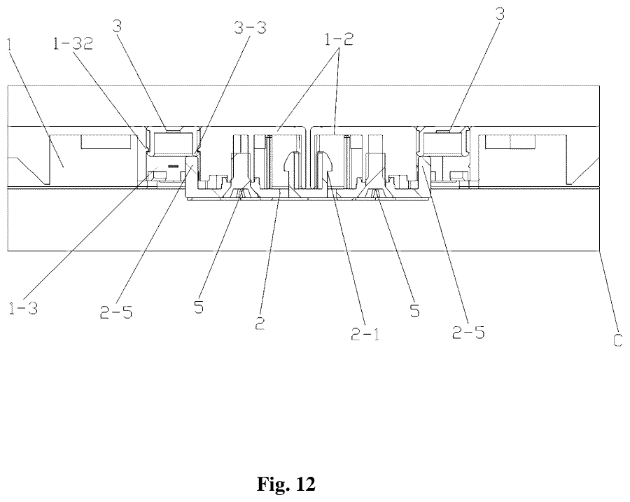

As shown in FIG. 11, the connecting plate 2 is respectively configured with one connecting plate edge bump 2-5 on the outer sides of the two connecting plate screw counter bores 2-2, and two connecting plate edge bumps 2-5 are inserted into the buckling holes 1-3 of the two left and right adjacent connecting portions 1-2 on the two pegboard bodies 1 in a one-to-one correspondence manner. As shown in FIG. 12, the ring wall end surfaces 3-3 of the buttons 3 in the buckling holes 1-3 of the two adjacent connecting portions 1-2 are respectively in one-to-one correspondence with the two connecting plate edge bumps 2-5, and when the screw connections between the two connecting plate screw counter bores 2-2 and the plate body screw holes 1-4 of the two connecting portions 1-2 are released, by pressing the buttons 3 in the buckling holes 1-3 of the two adjacent connecting portions 1-2 at the same time, the ring wall end surfaces 3-3 of the two buttons 3 can respectively push the two connecting plate edge bumps 2-5 to exit the buckling holes 1-3 of the two connecting portions 1-2, so that the two pegboard bodies 1 can be conveniently disassembled from the connecting plate 2.

In the present disclosure, in addition to being installed on the wall, the pegboard assembly of Embodiment 1 or Embodiment 2 can further adapt to a plurality of application scenarios, for example, being hung on an upper edge of a cabinet door or a room door, or clamped on an edge of a table plate.

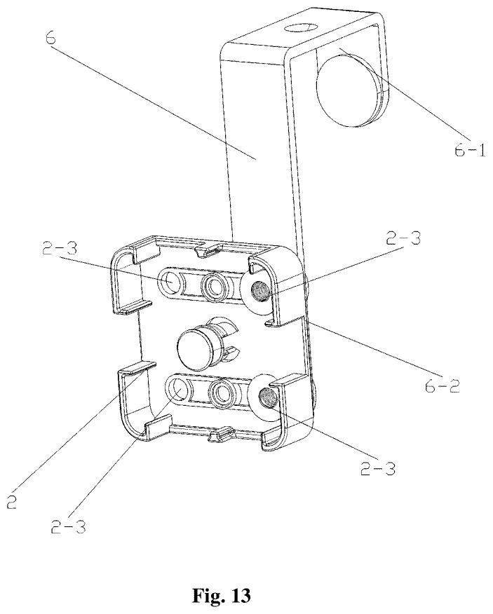

As shown in FIG. 13, the connecting plate 2 is configured with a plurality of bolt holes 2-3, an on-door hook 6 is connected to each bolt hole 2-3 by a bolt, the on-door hook 6 includes a hook portion 6-1 and a connecting portion 6-2, the connecting portion 6-2 is connected to the bolt hole 2-3 by a bolt, and the connecting plate 2 can be hung on the upper edge of the cabinet door or the room door by the hook portion 6-1.

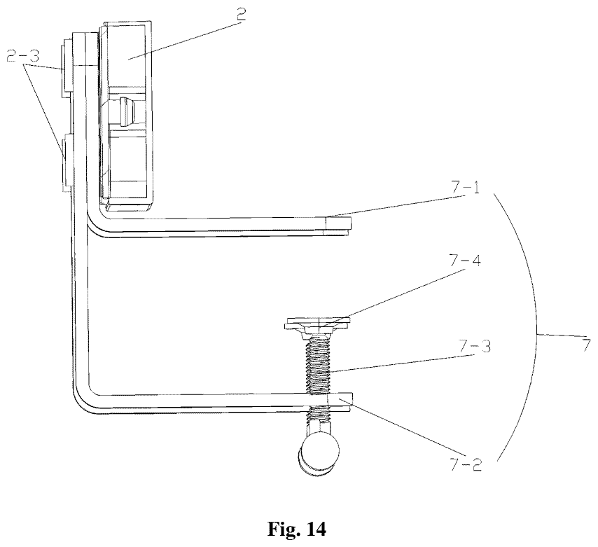

As shown in FIG. 14, a desktop connecting member 7 can also be connected to each bolt hole 2-3 by a bolt, the desktop connecting member 7 includes an upper clamping piece 7-1 and a lower clamping piece 7-2, which are L-shaped; upper portions of the upper clamping piece 7-1 and the lower clamping piece 7-2 are connected to the bolt holes 2-3 by bolts at the same time, a lower portion of the upper clamping piece 7-1 is opposite to a lower portion of the lower clamping piece 7-2, the lower portion of the lower clamping piece 7-2 is configured with an adjusting stud 7-3, a top end of the adjusting stud 7-3 is configured with a clamping cap 7-4, the distance between the clamping cap 7-4 and the lower portion of the upper clamping piece 7-1 can be adjusted by screwing the adjusting stud 7-3, the connecting plate 2 can be clamped on the edge of the table plate by the clamping cap 7-4 and the lower portion of the upper clamping piece 7-1.

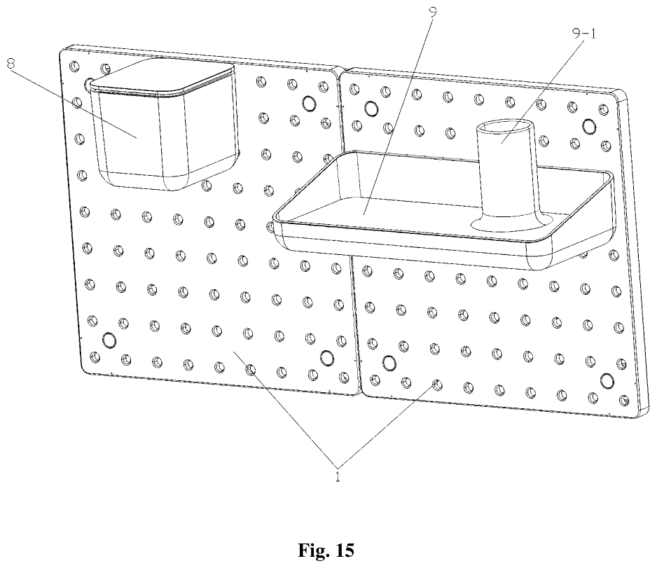

In addition to the hook, the pegboard assembly of the present disclosure can be further configured with a storage box 8 and a storage tray 9, as shown in FIG. 15, both the storage box 8 and the storage tray 9 can be hung on the hanging holes 1-1 for storing articles; the storage tray 9 can further be configured with a pen container 9-1 to facilitate the storage of stationery. The storage box 8 is a storage member, and the storage tray 9 also is a storage member.

The above descriptions are merely specific embodiments of the present disclosure, and are not intended to limit the scope of the present disclosure; and if not departing from the spirit and scope of the present disclosure, modifications or equivalent substitutions to the present disclosure shall fall within the protection scope of the claims of the present disclosure.

What is claimed is:

1. A pegboard assembly, comprising at least one pegboard body, wherein the pegboard body is configured with several hanging holes and at least one connecting portion and a connecting plate and a button are connected to the connecting portion; the connecting plate is in buckling connection with the connecting portion on a rear side of the pegboard body, and the connecting plate is used for installing the pegboard body on a wall or a door panel; and the button is connected with the connecting portion on a front side of the pegboard body, and the buckling connection between the connecting plate and the connecting portion is released by pressing the button.

2. The pegboard assembly as claimed in claim 1, wherein a buckling hole is formed inside the connecting portion, and an inner side wall of the buckling hole is configured with a connecting plate buckling position; the connecting plate is configured with a clamping convex column and a side wall of the clamping convex column is configured with a clamping hook; and the clamping convex column is inserted into the buckling hole, the clamping hook is in buckling connection with the connecting plate buckling position when the button is pressed, the button pushes the clamping convex column to move radially, and the clamping hook deviates from the connecting plate buckling position.

3. The pegboard assembly as claimed in claim 2, wherein the clamping convex column is configured with a convex column side edge groove and a front end of the clamping convex column is configured with a chamfer inclined plane a front end of the button is configured with a button ring wall, and an end surface of the button ring wall is opposite to the chamfer inclined plane and by pushing the button into the buckling hole, the front end of the clamping convex column is inserted into the button ring wall, the end surface of the button ring wall slides along the chamfer inclined plane and extrudes the clamping convex column radially, and the clamping convex column extrudes the convex column side edge groove to generate radial contraction until the clamping hook deviates from the connecting plate buckling position.

4. The pegboard assembly as claimed in claim 2, wherein the inner side wall of the buckling hole is configured with a button buckling position, and the button buckling position is located on a front side of the connecting plate buckling position an outer side wall of the button is configured with a button clamping hook; the button is inserted into the buckling hole, and the button clamping hook is in buckling connection with the button buckling position; and by pressing the button the button is caused to move towards a rear side of the buckling hole; and when the clamping convex column is inserted into the buckling hole the button is pushed to move towards a front side of the buckling hole- and the button buckling position limits the button.

5. The pegboard assembly as claimed in claim 3, comprising at least two pegboard bodies, wherein each of the at least two pegboard bodies is spliced up and down or spliced left and right; a spliced side of each of the at least two pegboard bodies is configured with the connecting portion, the connecting portion is configured with at least one plate body screw hole, and the plate body screw hole is located between the buckling hole and a spliced side wall of the pegboard body; the connecting plate is respectively configured with one connecting plate screw counter bore on two sides of the clamping convex column, and the clamping convex column is configured with the convex column side edge groove; and after two pegboard bodies are spliced together, one connecting plate is connected inside two connecting portions at a joint of the two pegboard bodies, the spliced side walls of the two pegboard bodies are embedded into the convex column side edge groove of the clamping convex column, and two connecting plate screw counter bores are in one-to-one correspondence with the plate body screw holes of the two connecting portions and are connected by screws.

6. The pegboard assembly as claimed in claim 5, wherein the connecting plate is respectively configured with one connecting plate edge bump on outer sides of two connecting plate screw counter bores, and when one connecting plate is connected inside the two connecting portions at the joint of the two pegboard bodies at the same time, two connecting plate edge bumps are inserted into the buckling holes of the two connecting portions in an one-to-one correspondence manner; and when screw connections between the two connecting plate screw counter bores and the plate body screw holes of the two connecting portions are released, the buttons in the buckling holes of the two connecting portions are pressed at the same time, the end surfaces of the button ring walls of two buttons respectively push the two connecting plate edge bumps to exit the buckling holes of the two connecting portions.

7. The pegboard assembly as claimed in claim 5, wherein the spliced side walls of the two pegboard bodies embedded into the convex column side edge groove are each configured with a plate body edge avoidance groove, the plate body edge avoidance groove is located on an inner side surface of the spliced side wall of the pegboard body, and the spliced side walls of the two pegboard bodies are embedded into the convex column side edge groove at positions where the plate body edge avoidance grooves are located.

8. The pegboard assembly as claimed in claim 5, wherein a periphery of the connecting plate is configured with side walls; two side walls of the connecting plate, respectively opposite to two ends of the convex column side edge groove, are both configured with connecting plate side wall avoidance grooves; two connecting plate side wall avoidance grooves are opposite to each other; and when one connecting plate is connected inside the two connecting portions at the joint of the two pegboard bodies at the same time, the spliced side walls of the two pegboard bodies are embedded into two opposite connecting plate side wall avoidance grooves.

9. The pegboard assembly as claimed in claim 3, wherein, a back surface of the connecting plate is configured with a back adhesive, and the back adhesive is used for pasting the connecting plate on the wall or a door; or the connecting plate is configured with a fixing screw hole, and the connecting plate is connected to the wall with screw through the fixing screw hole.

10. The pegboard assembly as claimed in claim 3, wherein the connecting plate is configured with at least two bolt holes an on-door hook is connected to each bolt hole by a bolt; the on-door hook comprises a hook portion and a connecting portion, the connecting portion is connected to the bolt hole by a bolt, and the hook portion is used for hanging the connecting plate on an upper edge of a cabinet door or a room door.

11. The pegboard assembly as claimed in claim 3, wherein the connecting plate is configured with at least two bolt holes, a desktop connecting member is connected to each bolt hole by a bolt; the desktop connecting member comprises an upper clamping piece and a lower clamping piece, which are L-shaped; upper portions of the upper clamping piece and the lower clamping piece are connected to the bolt holes by bolts at the same time, a lower portion of the upper clamping piece is opposite to a lower portion of the lower clamping piece; the lower portion of the lower clamping piece is configured with an adjusting stud, a top end of the adjusting stud is configured with a clamping cap, a distance between the clamping cap and the lower portion of the upper clamping piece is adjusted by screwing the adjusting stud, and the clamping cap and the lower portion of the upper clamping piece are used for clamping the connecting plate on an edge of a table plate.

12. The pegboard assembly as claimed in claim 3, wherein the pegboard body is configured with a storage box and/or a storage tray, the storage box and/or the storage tray is hung on the hanging holes, and the storage tray is configured with a pen container.

13. The pegboard assembly as claimed in claim 3, wherein the inner side wall of the buckling hole is provided with a button buckling position, and the button buckling position is located on the front side of the connecting plate buckling position; the outer side wall of the button is provided with a button clamping hook; the button is inserted into the buckling hole, and the button clamping hook is in buckling connection with the button buckling position; and by pressing the button, the button may be caused to move towards the rear side of the buckling hole, and when the clamping convex column is inserted into the buckling hole, the button may be pushed to move towards the front side of the buckling hole and the button buckling position limits the button.

14. The pegboard assembly as claimed in claim 5, wherein a back surface of the connecting plate is provided with a back adhesive, and the back adhesive is used for pasting the connecting plate on a wall or a door; or the connecting plate is provided with a fixing screw hole, and the connecting plate is connected to the wall by the fixing screw hole.

15. The pegboard assembly as claimed in claim 5, wherein the connecting plate is provided with at least two bolt holes, a on-door hook is connected to each bolt hole by a bolt, the on-door hook comprises a hook portion and a connecting portion, the connecting portion is connected to the bolt hole by a bolt, and the hook portion is used for hanging the connecting portion on an upper edge of a cabinet door or a room door.

16. The pegboard assembly as claimed in claim 5, wherein the connecting plate is provided with at least two bolt holes, a desktop connecting member is connected to each bolt hole by a bolt, the desktop connecting member comprises an upper clamping piece and a lower clamping piece, which are L-shaped, upper portions of the upper clamping piece and the lower clamping piece are connected to the bolt hole by bolts at the same time, a lower portion of the upper clamping piece is opposite to a lower portion of the lower clamping piece, the lower portion of the lower clamping piece is provided with an adjusting stud, a top end of the adjusting stud is provided with a clamping cap, the distance between the clamping cap and the lower portion of the upper clamping piece may be adjusted by screwing the adjusting stud, and the clamping cap and the lower portion of the upper clamping piece are used for clamping the connecting plate on the edge of a table plate.

17. The pegboard assembly as claimed in claim 5, wherein the pegboard body is provided with a storage box and/or a storage tray, the storage box and/or the storage tray are hung on the hanging hole, and the storage tray is provided with a pen container.
